(19) United States
(12) Patent Application Publication
(10) Pub. No.: US 2002/0032992 A1
(43) Pub. Date: Mar. 21, 2002

(54) Extendable support structure of deformable tube elements

(76) Inventors: Martin Roth, Taufkirchen (DE); Franz Sperber, Kolbermoor (DE); Walter Stich, Miesbach (DE)

Correspondence Address: CROWELL & MORING, L.L.P., P.O. Box 14300, Washington, DC, 20044-4300, US

(21) Appl. No.: 09/944,146

(22) Filed: Sep. 4, 2001

(30) Foreign Application Priority Data
Sep. 2, 2000 (DE) 100 43 249.2

(51) Int. Cl. E04H 12/34; B66C 23/06; B66C 23/62; E04H 12/18

(52) U.S. Cl. 52/109; 52/111; 52/121

(57) ABSTRACT

An extensible carrier structure is described here which includes several mutually connected individual elements, where the individual elements are made up of tube elements which are deformable in a reversible manner, and where the tube elements, at their ends, are connected with each other by first elastic elements.

### BACKGROUND AND SUMMARY OF THE INVENTION

This application claims the priority of German patent document no. 100 43 249.2, filed Sep. 2, 2000, the disclosure of which is expressly incorporated by reference herein.

This invention relates to an extensible carrier structure that is made up of several mutually connected individual elements, in particular, for uses in space technology. Such a carrier structure, for example, can serve as a mast structure or as a strut structure and can also be employed independently of uses in space travel.

Such a mast structure is known, for instance, from European Patent Document 0 858 946 and corresponding U.S. Pat. No. 5,857,648, where a mast, consisting of individual struts, connected with each other in scissors fashion, is described. In German Patent Document 2 110 626 and corresponding U.S. Pat. No. 3,735,942, struts made of individual elements are disclosed that are flexibly connected with each other at their ends. Besides, struts described there are the ones that are formed by rolling a strip off with internal mechanical stress (measurement tape effect). In German Patent Document 32 23 839, a folding solar generator is described that is retained by a folding mast made up of individual mast segments.

There is, however, a disadvantage inherent in this state of the art to get the necessary mechanical rigidity when the carrier structure is in the extended state, one needs very massive individual elements, which, again, require a large stowage volume when the structure is in the stowed state. If, on the other hand, one employs the variant of rolling off a prestressed material, one can ensure a high degree of rigidity when in the extended state. However, there is the danger of the mechanical destruction of the carrier material by the severe deformation that occurs during stowage in the rolled-up state.

The object of the invention therefore is to provide an extensible carrier structure that will ensure the smallest possible stowage volume, during the retracted state, coupled with maximum possible rigidity in the extended state.

This problem is solved in certain preferred embodiments by an extendable support structure comprising several mutually connected individual elements wherein the individual elements are made of tube elements which are deformable in a reversible manner so that a change can take place in a cross section surface of the tube elements, perpendicular to a longitudinal extent, and the tube elements are connected with each other at ends by way of first elastic elements.

According to certain preferred embodiments of the invention, the extendable carrier structure has tube elements as individual elements that can be so deformed in a reversible manner that there can be a change of the cross section surface of the tube elements perpendicularly with respect to their longitudinal extent. The tube elements can thus be compressed by a force action or a prestress perpendicularly with respect to their longitudinal extent, which reduces the required stowage volume for the tube elements. If the force action or prestress is removed again, then the tube elements, in a reversible manner, return to their original shape. On the other hand, the design of the individual elements as tube elements ensures a high degree of rigidity for the individual elements the moment the force action or prestress are lifted.

The tube elements are connected at their ends by elastic elements. In that way, the tube elements can be stowed in accordion fashion, as a result of which one can form a stack of individual tube elements that lie upon each other, perpendicular, to the longitudinal extent of the extended carrier structure. One, thus, gets a very compact stowage possibility for the individual tube elements, and the stowage volume can be further reduced by exerting a corresponding force or prestress, as described above, via a deformation of the tube elements. On the other hand, by suitably adjusting the internal mechanical prestress of the elastic elements, one can make sure that, if the force or the prestress are lifted, the carrier structure will unfold automatically due to this prestress of the mechanical elements, thus leading to the extension of the structure. The internal prestress of the elastic elements also guarantees the rigidity of the structure in the extended state.

To ensure the reversible deformability of the tube elements, the tube elements are made elastic. The tube elements themselves can be an elastic material. But, one can also provide that the tube elements include partial segments that extend in the longitudinal direction of the tube elements and that are connected with each other, along surface lines of the tube elements, by way of additional elastic elements or joints. When elastic elements are provided, the individual subsegments can offer elasticity which, however, as a rule, can be designed to less than the elasticity of the additional elastic elements.

The first elastic elements can, for example, have leaf springs at the ends of the tube elements and/or the other elastic elements along the surface lines of the sub-segments, if such are provided. In order to further stiffen the connection of the individual tube elements by way of elastic elements, one can provide that each tube element be connected by two elastic elements with each tube element adjoining in the longitudinal direction, where each elastic element can have two opposite leaf springs, with opposite curvature, perpendicular to the longitudinal direction, so that, when in the extended state, the individual leaf springs of the elastic elements, against each other, increase the action and stiffness of each elastic element.

Basically, the tube elements can be arranged in a single row of mutually connected tube elements so that, when in the extended state, one gets a single carrier. For example, one single strut or one single mast. But, one can also provide at least one first tube element being connected at a first end with a first end of a second tube element and, on a second end, with a second end of third, fourth, and fifth tube elements. As a result, one can form two mutually parallel rows of tube elements; the rows are so connected with each other that every other connection of the tube elements of the first row will be connected with every other connection of the tube elements of the second row. In the extended state, they will form a double carrier structure, for example, a double strut or a double mast. This will hereafter be called double structure, for short. The rigidity of the carrier structure can be further increased by such a measure.

In addition to the elastic elements, such as leaf springs, one can provide additional auxiliary joints that have cable rolls and that are connected with a cable gear, so that one can guarantee a controlled, uniform extension of the carrier structure. The basic way in which such cable gears work is known, for instance, from German Patent Document 197 28 844 and corresponding U.S. Pat. No. 6,008,447.

Basically, one can employ all suitable materials, in particular, elastic materials, for the tube elements. For example, the tube elements can be made of a carbon fiber material. Such a material offers the additional advantage of low weight with relatively great rigidity.

The carrier structures can basically be used in any field in which one needs a small stowage volume, coupled with simultaneously high rigidity of the structure. Such structures are very specially used in devices for a space vehicle, such as a satellite or a space shuttle, in particular, in antenna devices or solar generator devices, because, especially in the case of space vehicles, one tries to get the smallest possible stowage volume and, preferably, also a low weight for all of the various units, in order to be able to place as many devices in a limited space and to keep the necessary fuel, for transporting the space vehicle into the universe, as small as possible.

A special exemplary embodiment of this invention will be described below with reference to FIGS. 1 to 7.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a profile through superposed, deformed tube elements in the stowed state;

FIG. 2 shows a diagram illustrating an elastic element at the end of the tube elements;

FIG. 3 shows a diagram illustrating an elastic element along a surface line of a tube element;

FIG. 4 shows a profile through a double structure in the extended state;

FIG. 5 shows a view of a connection of tube elements of a double structure by elastic elements;

FIG. 6 shows a view of an elastic element according to FIG. 5;

FIG. 7 shows an illustration of the extension of a double structure;

FIG. 8 shows a connection according to FIG. 5 with auxiliary joints and cable gear; and

FIG. 9 shows the articulated connection of pipe elements and cross beams at the end of the double structure.

### DETAILED DESCRIPTION OF THE DRAWINGS

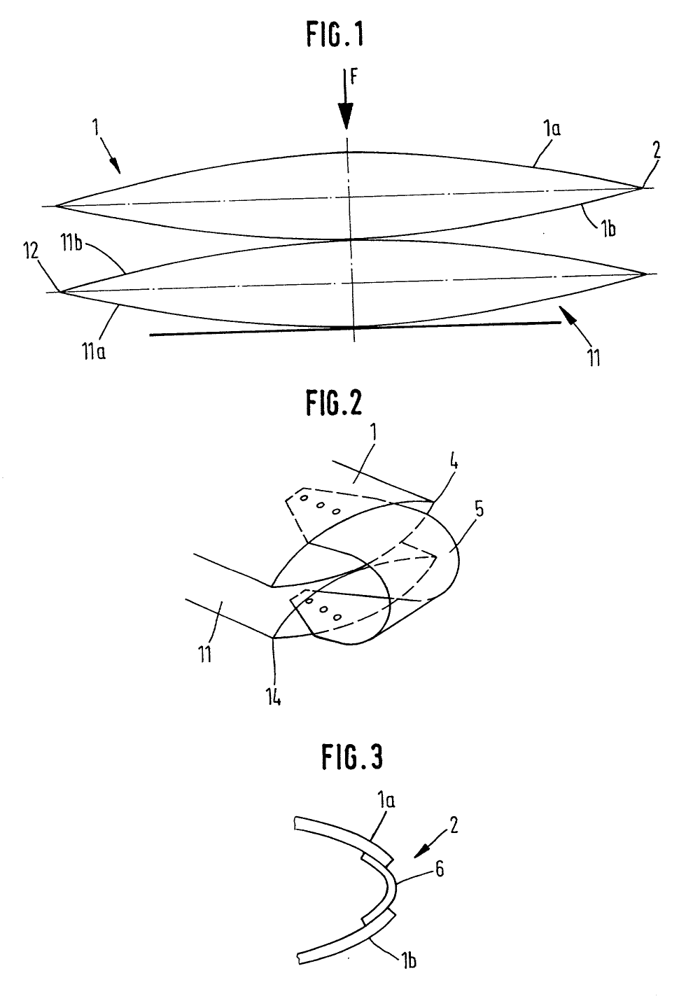

As in FIG. 1, two superposed, deformed tube elements 1, 11 in the stowed state are shown; the lower tube element 11, for example, is supported by an additional tube element or supporting surface, not shown. A perpendicularly acting force or prestress F is exerted upon the upper tube element 1; this force leads to a deformation of tube elements 1, 11, as a result of which the illustrated profile surface changes perpendicularly with respect to the longitudinal extent of tube elements 1, 11. Similar features are referenced with like reference numerals throughout the Figures.

Tube elements 1, 11, in FIG. 1, includes two, each, semicylindrical, hollow subsegments 1 a, 1 b, 11 a, 11 b, which, in each case, have a certain degree of elasticity. These subsegments are made, for example, of a carbon fiber material. On intersection lines 2, 12, along surface lines of tube elements 1, 11, subsegments 1 a, 1 b, 11 a, 11 b are connected with each other by elastic elements 6, such as leaf springs or, alternatively, by joints, as shown in FIG. 3.

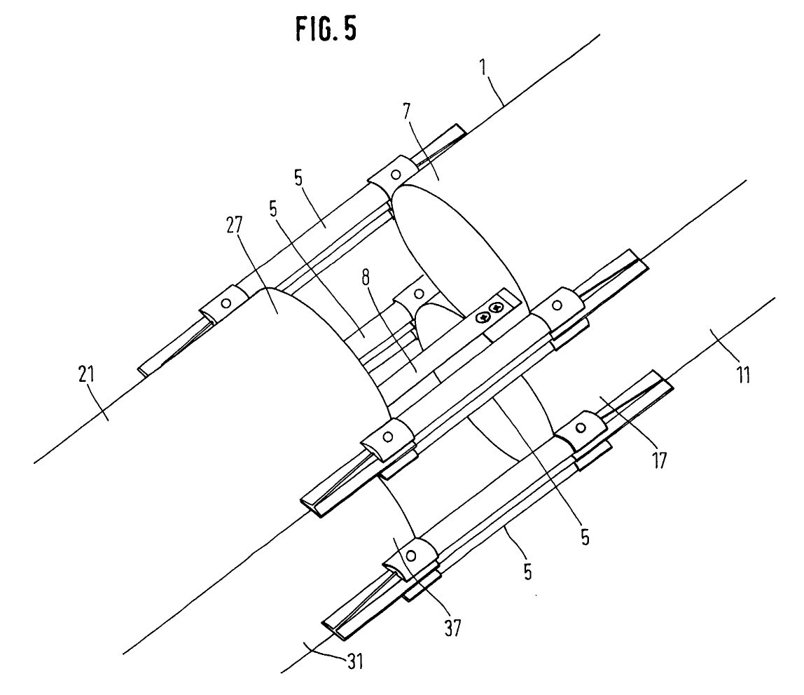

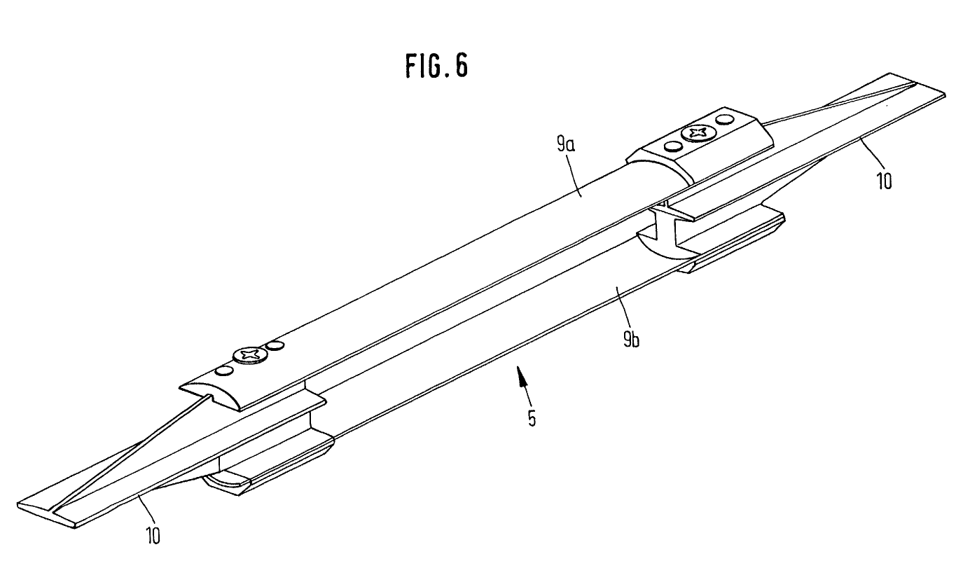

At their ends 4, 14, tube elements 1, 11 are connected with each other by elastic elements 5, such as leaf spring arrangements, as is illustrated in the diagram in FIG. 2. The latter shows an individual strut or an individual mast, that is to say, the mast or the strut would in this case be formed only by an individual row of tube elements 1, 11. The special shape of the elastic elements can be adapted depending on the specific requirements for elasticity and rigidity as shown, for example, in FIGS. 5 and 6.

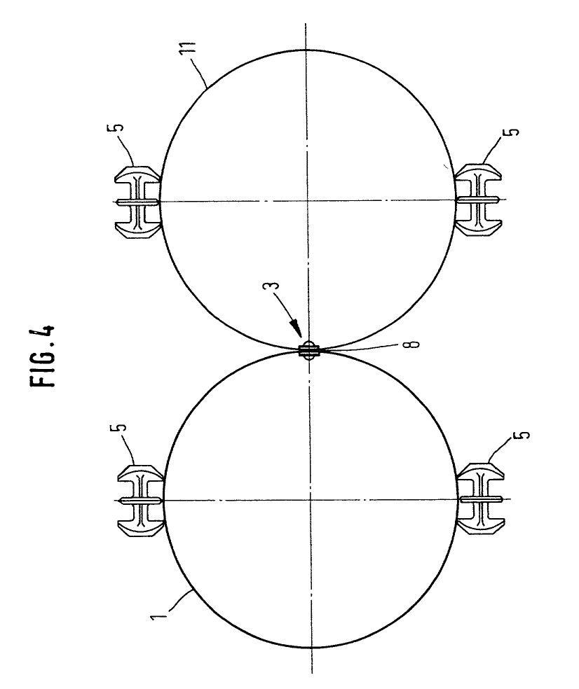

FIG. 5 shows a view of a double structure with four tube elements 1, 11, 21, 31, in the extended state, where tube elements 1 and 21 are arranged behind each other in the longitudinal direction and where tube elements 11 and 31 are also arranged in the longitudinal direction, behind each other, but parallel to tube elements 1 and 21. This is also shown in the profile in FIG. 4.

The tube elements 1, 21 and 11, 31, that are arranged in series behind each other, are in each case connected with each other by two elastic elements 5, which are arranged, mutually opposite, on the generated surface of tube elements 1, 11, 21, 31. Elastic elements 5, illustrated in more detail in FIG. 6, comprise retention devices 10 that are firmly connected with tube elements 1, 11, 21, 31, and (also comprise) leaf spring pairs 9a, 9b, which are connected to retention devices 10 and are curved perpendicularly to the longitudinal direction. The curvature of leaf spring 9a is opposite to the curvature of leaf spring 9b so that, when the structure is in the extended state, in which the leaf springs assume the stretched-out form shown in FIG. 6, in case of a possible force action upward, leaf spring 9a and, in case of a possible force action downward, leaf spring 9b, can guarantee the rigidity of elastic element 5.

Tube elements 1, 11, 21, 31 furthermore are connected with each other at one of their ends 7, 17, 27, 37, as shown in FIG. 5. A connection 8 is provided, for example, in the form of two superposed level leaf springs that are connected with each other in their middle, with each of these leaf springs being connected at one of its ends with a tube element 1, 11, 21, 31. This connection thus forms an X-shaped hinge joint, so that tube elements 1, 11, 21, 31 can be swung against each other. When the structure is in the extended state, tube elements 1 and 11 as well as 21 and 31, however, adjoin each other in an area of a surface line 3, as shown in FIG. 4.

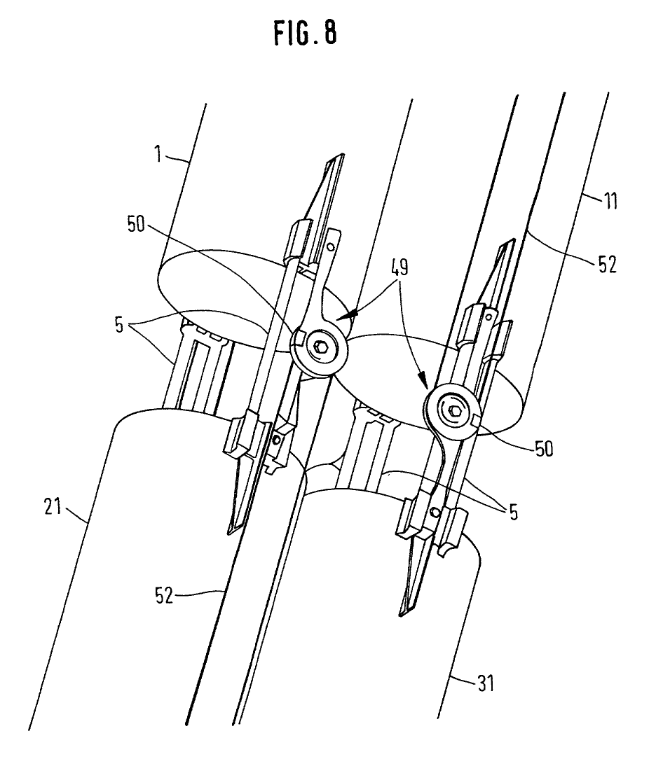

To facilitate an additional defined extension of the carrier structure, one can, as shown in FIG. 8, make provision for additional auxiliary joints 49 with cable rolls 50 to be connected with elastic elements 5. Cable rolls 50 are connected with a cable gear 52 with, in each case, a neighboring cable roll 50. Cable gear 52 can be set up so that all tube elements will be extended simultaneously and uniformly, instead of a successive extension of the individual, originally superposed tube elements.

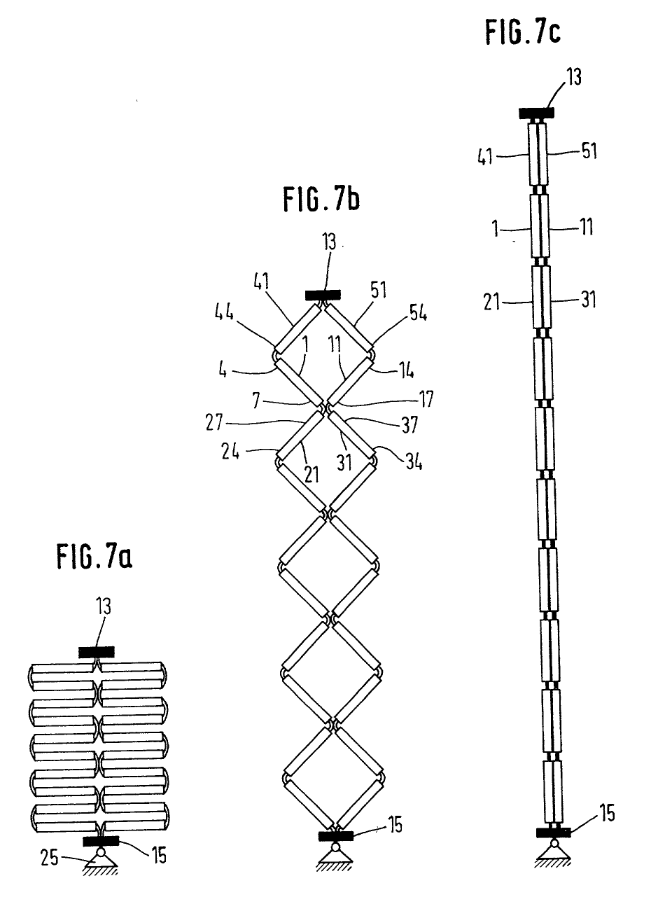

FIGS. 7a-7c show the extension of the structure according to FIG. 5 from a stowed state (a) into a partially extended state (c). In the stowed state (a), the tube elements lie on top of each other in two stacks, perpendicular to the direction of extension, and are retained, between an upper cross beam 13 and a lower cross beam 15, with a prestress that deforms the tube elements in order to achieve the smallest possible stowage volume. The lower cross beam is connected in an articulated manner with a base structure 25, such as a space vehicle.

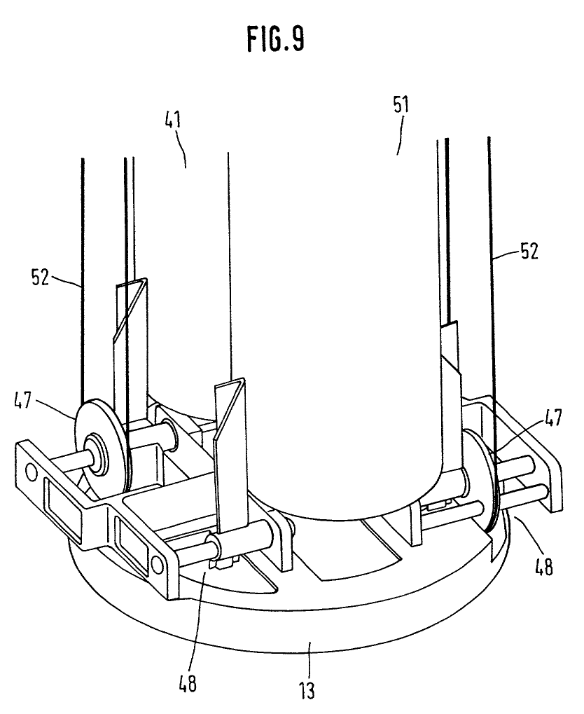

If the prestress is lifted, then flexible elements 5, at the ends of the tube elements, cause the unfolding and thus the extension of the structure. The final position (c) is reached here via a state shown in FIG. 7b. Tube elements 1, 11, 21, 31, 41, 51, etc., are uniformly extended in a manner controlled by the cable gear 52. Tube elements 1 and 41 are connected with each other at the first ends 4, 44, and tube elements 11 and 51 are connected with each other at the first ends 14 and 54. Tube elements 41 and 51 moreover are flexibly connected with the upper cross beam 13, as shown in detail in FIG. 9. Flexible connections 48 are provided for this purpose between cross beam 13 and tube elements 41, 51. The cable gear 52 also extends all the way to cross beam 13 where additional cable rolls 47 are provided in the area of the articulated connections. A similar flexible connection can be provided in the area of the base structure 25.

As indicated in FIG. 7b, tube elements 1 and 11 are connected with each other at their second ends 7, 17 and are connected with the second ends 27, 37 of the adjoining tube elements 21, 31. Therefore, the structure continues to be held together in the state shown in FIG. 7b, and tube elements 41 and 51 as well as 1 and 11 automatically are arranged parallel to each other, as shown in FIG. 7c. The extension procedure is continued up to the complete extension of the double structure. This terminal state is illustrated in FIG. 7c.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An extendable support structure, comprising several mutually connected individual elements, wherein
the individual elements are made of tube elements which are deformable in a reversible manner so that a change can take place in a cross section surface of the tube elements, perpendicular to a longitudinal extent, and
the tube elements are connected with each other at ends by way of first elastic elements.

2. An extendable support structure according to claim 1, wherein the tube elements are an elastic material.

3. An extendable support structure according to claim 1, wherein the tube elements includes subsegments, which extend in the longitudinal direction of the tube elements and are connected with each other along surface lines of the tube elements by way of second elastic elements or joints.

4. An extendable support structure according to claim 2, wherein the tube elements includes subsegments, which extend in the longitudinal direction of the tube elements and are connected with each other along surface lines of the tube elements by way of second elastic elements or joints.

5. An extendable support structure according to claim 1, wherein the first elastic elements include leaf springs.

6. An extendable support structure according to claim 2, wherein the first elastic elements include leaf springs.

7. An extendable support structure according to claim 3, wherein at least one of the first and second elastic elements include leaf springs.

8. An extendable support structure according to claim 1, wherein
each of the tube elements is connected by way of two of the first elastic elements with each of the tube elements adjoining in the longitudinal direction, each of the first elastic element having two opposing leaf springs with opposite curvature perpendicular to the longitudinal direction.

9. An extendable support structure according to claim 1, wherein at least one of the tube elements at a first end is connected with a first end of a second of the tube elements and
on a second end is connected with a second end of a third, fourth, and fifth of the tube elements.

10. An extendable support structure according to claim 2, wherein at least one of the tube elements at a first end is connected with a first end of a second of the tube elements and
on a second end is connected with a second end of a third, fourth, and fifth of the tube elements.

11. An extendable support structure according to claim 3, wherein at least one of the tube elements at a first end is connected with a first end of a second of the tube elements and
on a second end is connected with a second end of a third, fourth, and fifth of the tube elements.

12. An extendable support structure according to claim 5, wherein at least one of the tube elements at a first end is connected with a first end of a second of the tube elements and
on a second end is connected with a second end of a third, fourth, and fifth of the tube elements.

13. An extendable support structure according to claim 8, wherein at least one of the tube elements at a first end is connected with a first end of a second of the tube elements and
on a second end is connected with a second end of a third, fourth, and fifth of the tube elements.

14. An extendable support structure according to claim 1, wherein auxiliary joints are provided having cable rolls and are connected with a cable gear.

15. An extendable support structure according to claim 2, wherein auxiliary joints are provided having cable rolls and are connected with a cable gear.

16. An extendable support structure according to claim 3, wherein auxiliary joints are provided having cable rolls and are connected with a cable gear.

17. An extendable support structure according to claim 5, wherein auxiliary joints are provided having cable rolls and are connected with a cable gear.

18. An extendable support structure according to claim 8, wherein auxiliary joints are provided having cable rolls and are connected with a cable gear.

19. An extendable support structure according to claim 9, wherein auxiliary joints are provided having cable rolls and are connected with a cable gear.

20. An extendable support structure according to claim 1, wherein the tube elements are a carbon fiber material.

21. An extendable support structure according to claim 2, wherein the tube elements are a carbon fiber material.

22. An extendable support structure according to claim 9, wherein the tube elements are a carbon fiber material.

23. An extendable support structure, comprising:
at least two elements which are mutually connected and include tube elements, said tube elements being reversibly deformable in a cross-section perpendicular to an axial extent of the tube elements, and
first elastic elements connecting the tube elements with each other at at least one end of the tube elements, wherein
a force action automatically extending the support structure is provided by the reversibly deformable cross-section or the first elastic elements.

24. An extendable support structure according to claim 23, wherein the force action positions the tube elements axially to one another.

25. An extendable support structure according to claim 23, wherein the reversibly deformable cross-sections deforms upon an applied force to flatten the tube elements in order to minimize a storage volume of the support structure.

26. An extendable support structure according to claim 23, wherein the first elastic elements include leaf springs.

27. An extendable support structure according to claim 23, wherein the tube elements includes subsegments, which extend in the longitudinal direction of the tube elements and are connected with each other along surface lines of the tube elements by way of second elastic elements or joints.

28. A method of making an extendable support structure, comprising:
providing several tube elements,
mutually connecting the tube elements axially with each other at respective ends by first elastic elements,
applying a force to the tube elements to fold the tube elements towards one another and to reversibly deform a cross-section of the tube elements perpendicular to an axial extent of the tube elements so that a stowage volume of the support structure is minimized.

29. A method of making an automatically extendable support structure, comprising:
providing at least two tubes which are reversibly deformable in a cross-section perpendicular to a longitudinal extent of the tube elements,
connecting the tube elements with each other at ends by elastic elements so that the tube elements in a deformed position are prestressed in order to automatically extend.
